(19) United States
(12) Patent Application Publication
(10) Pub. No.: US 2022/0056240 A1
(43) Pub. Date: Feb. 24, 2022

(54) COMPOSITE MATERIAL

(71) Applicant: LOUGHBOROUGH UNIVERSITY, Leicestershire (GB)

(72) Inventors: Robert CROOKES, Leicestershire (GB); Houzheng WU, Leicestershire (GB); Gary CRITCHLOW, Leicestershire (GB)

(21) Appl. No.: 17/299,473

(22) PCT Filed: Dec. 3, 2018
(86) PCT No.: PCT/GB2018/053494

§ 371 Date: Jun. 3, 2021

(51) Int. Cl. C08K 7/00; C08K 9/06; C08J 3/20; F41H 5/04

(52) U.S. Cl. CPC C08K 7/00; C08K 9/06; C08J 3/201; F42D 5/045; C08K 2201/016; C08K 2201/003; F41H 5/0492

(57) ABSTRACT

A composite material comprising an elastomer having ceramic platelets dispersed therein, and applications thereof including an armour system. The ceramic platelets each have a first plate surface and a second plate surface, the first and second plate surfaces being separated by a height H. The ceramic platelets each having a maximum diameter D measured in the first and second plate surfaces. The ceramic platelets have a mean height Hₘ and a mean maximum diameter Dₘ. The mean height Hₘ is 0.1 to 1 μm and the ratio Dₘ:Hm is 20 or more.

### FIELD OF THE INVENTION

The present invention relates to a composite material, a method for the preparation of the composite material and applications thereof.

### BACKGROUND OF THE INVENTION

There is interest in natural structures for use in armour and impact applications. The most common of which is nacre, a brick and mortar like arrangement of 95% aragonite (calcium carbonate) platelets in a natural polymer. This material exhibits very high degrees of toughness, three orders of magnitude greater than that of aragonite, whilst maintaining high strength. The material derives its properties from its sub-micro and nano scale hierarchical structure. The properties of the soft polymer layer between platelets is one of the key factors affecting the performance of this natural composite, governing how platelets interact during deformation, with the sliding of plates being one of the main stress redistribution mechanisms. GB 1260111 describes a sheet for resisting projectiles, which comprises ceramic plates having a minimum dimension of one tenth of an inch (2.54 mm) in the plane of the sheet. U.S. Pat. No. 3,684,631 describes an armour fabrication comprising laminae consisting of a series of discus shaped platelets retained together in a layered, overlapping geometric pattern, such that no body free path exists through the armour. The platelet diameters are said to be of the order of several inches (1 inch=25.4 mm).

Methods have been developed for the manufacture of highly aligned platelet reinforced composites, with chemical, mechanical and biomimetic methods all being trialled. Bonderer et al (J. Mater. Res. 24, 2741-2754 (2009)) describes a “Bottom up” layer by layer manufacture which produces highly ordered structures. However it is not scalable. Hot press assisted slip casting (HASC) and tape casting techniques are suitable for low viscosity thermoset composites but cannot be applied to high viscosity thermoplastic melts.

### SUMMARY OF THE INVENTION

According to a first aspect of the invention there is provided a composition comprising an elastomer having ceramic platelets dispersed therein,

the ceramic platelets each having a first plate surface and a second plate surface, the first and second plate surfaces being separated by a height H;

the ceramic platelets each having a maximum diameter D measured in the first and second plate surfaces; and

the ceramic platelets having a mean height Hₘ and a mean maximum diameter Dₘ; wherein Hₘ is 0.1 to 1 m and the ratio Dₘ:Hₘ is 20 or more.

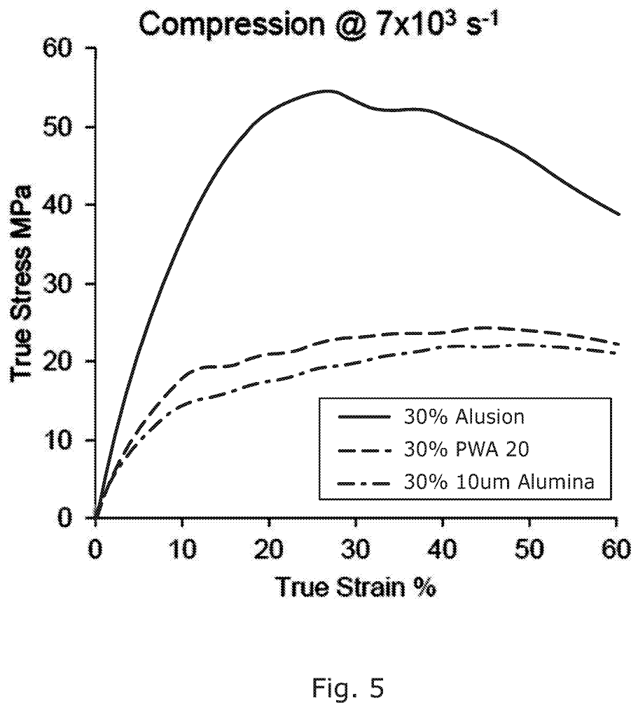

The inventors have determined that the composition of the first aspect (a composite material) provides benefits relative to compositions comprising ceramic particles having different sizes and shapes (see FIG. 5 for example). The platelets provide high levels of structural reinforcement which results in increased elastic modulus, hardness and ultimate strength.

According to a second aspect of the invention there is provided a method for the preparation of a composition, the method comprising

dispersing ceramic platelets in an elastomer,

the ceramic platelets each having a first plate surface and a second plate surface, the first and second plate surfaces being separated by a height H;

the ceramic platelets each having a maximum diameter D measured in the first and second plate surfaces; and

the ceramic platelets having a mean height Hₘ and mean maximum diameter Dₘ; wherein Hₘ is 1 m or less and the ratio of Dₘ:Hₘ is 20 or more.

It will be understood that the method can be employed to prepare the composition of the first aspect.

According to a third aspect of the invention there is provided the use of a composition in accordance with the first aspect of the invention for ballistic impact protection or for vibration damping.

According to a fourth aspect of the invention there is provided an armour system comprising a rigid substrate and the composition of the first aspect.

According to fifth aspect of the invention there is provided an anti-vibration mount comprising the composition of the first aspect.

### DETAILED DESCRIPTION OF THE INVENTION

Ceramic Platelets

A ceramic platelet is an inorganic particle having a plate-like/planar shape.

It will be understood that the ceramic platelets have high modulus, hardness and tensile strength.

The ceramic may be a metal oxide, a metal nitride and/or a metal carbide, e.g. alumina, aluminium oxynitride, boron nitride, boron carbide, silicon carbide or silicon nitride. It will be understood that graphite platelets are not ceramic platelets within the context of the invention. The ceramic platelets may comprise a metal oxide, such as aluminium e.g. alumina (Al₂O₃) platelets.

The ceramic platelets each have a first surface and a second surface, separated by a height H. Each ceramic platelet has a maximum diameter D (i.e. maximum dimension), which is the maximum diameter that can be measured in the first and second surfaces. The group of ceramic platelets has a mean maximum diameter Dₘ and a mean height Hₘ. The invention is concerned with the ratio of these values Dₘ:Hₘ.

The dimensions of the ceramic platelets can be determined from SEM imaging or via LASER diffraction (e.g. using the Malvern® Mastersizer). The ceramic platelets employed in the examples have a mean diameter Dₘ of 12.66 μm (SD 2.28) and a mean height Hₘ of 0.36 μm (SD 0.08). As such, the ratio Dₘ:Hₘ is 35.2.

The ratio Dₘ:Hₘ is 20 (i.e. 20:1) or more. The ratio Dₘ:Hₘ may be 25 or more, 30 or more or 35 or more and/or the ratio Dₘ:Hₘ may be 100 or less, 80 or less, 60 or less, 50 or less, or 40 or less. The ratio Dₘ:Hₘ may be 20 to 50.

The mean height of the ceramic platelets Hₘ is 1 m (1000 nm) or less and at least 100 nm. Hₘ may be 800 nm or less, 600 nm or less, 500 nm or less or 400 nm or less and/or Hₘ may be 200 nm or more or 300 nm or more. Hₘ may be 300 to 400 nm.

The scaling of the platelets is very important. Without being bound by theory, the inventors propose that if they are nano-scale (Hₘ<100 nm) then they will interrupt molecular motions of the polymer and result in a brittle composite.

The mean maximum diameter of the ceramic platelets Dₘ may be 30 μm or less, 20 μm or less, 15 μm or less, or 13 μm or less and/or Dₘ may be 5 m or more, 10 μm or more or 12 μm or more. Dₘ may be 5 to 20 m.

The ceramic platelets may be treated with a surface modifier (e.g. a silane treatment) if desired. Surface treatment may be employed to improve bonding between the platelets and the elastomer and to assist in the dispersion of the platelets.

Elastomer

An elastomer is an elastic polymer i.e. a polymer with the property of elasticity. As such it deforms under stress and returns to its original shape when the stress is removed. The elastomer may be defined by large elastic deformations, typically greater than 50%, with a Young's modulus equal to or less than 2 GPa.

Suitable elastomers include butyl rubber, polyisobutylene (PIB), natural rubber (polyisoprene), polybutadiene rubber (BR), styrene-butadiene rubber (SBR), nitrile rubber (NBR), chloroprene rubber (CR), ethylene propylene rubber (EPM), ethylene propylene diene rubber (EPDM), and silicone.

The elastomer may comprise a vulcanised rubber. Traditionally, vulcanization referred to the treatment of natural rubber with sulphur but now the term includes the hardening of other (synthetic) rubbers.

The elastomer comprise an elastomer that can be cured by sulphur or peroxide vulcanisation, such as butyl rubber, natural rubber (polyisoprene), polybutadiene rubber (BR), styrene-butadiene rubber (SBR), nitrile rubber (NBR), chloroprene rubber (CR), ethylene propylene rubber (EPM), and ethylene propylene diene rubber (EPDM). Such elastomers are preferred for ballistics and damping applications. Butyl rubber is a synthetic rubber, a copolymer of isobutylene with isoprene, which is also known as IIR (isobutylene isoprene rubber). Butyl rubber is produced by polymerization of about 98% of isobutylene with about 2% of isoprene. Butyl rubber contains 2% unsaturated double bonds that allow cross-linking.

Polyisobutylene (PIB, (C₄H₈)ₙ), is the homopolymer of isobutylene. Structurally, polyisobutylene resembles polypropylene, but has two methyl groups substituted on every other carbon atom, rather than one.

Nitrile butadiene rubber (NBR) is a family of unsaturated copolymers of 2-propenenitrile (acrylonitrile) and various butadiene monomers (1,2-butadiene and 1,3-butadiene).

Chloroprene rubber (CR) is also known as polychloroprene and Neoprene®.

The elastomer may comprise an unsaturated rubber and/or a saturated rubber. Natural rubber, butyl rubber, nitrile rubber, and chloroprene rubber are unsaturated rubbers whereas PIB, EPDM, EPM and silicone are saturated rubbers. The elastomer may comprise one or more saturated rubbers, optionally blended with one or more unsaturated rubbers. For example, the elastomer may comprise natural rubber/butyl rubber/nitrile rubber, optionally blended with PIB.

The elastomer may comprise butyl rubber and/or PIB, e.g. the elastomer may comprise a blend of butyl rubber and PIB.

The elastomer may not comprise polyurethane. Polyurethane has higher cost and complexity than vulcanised rubbers and can suffer from increased toxicity.

Composite Material

The composition in accordance with the invention is a composite material i.e. a material made from two or more constituent materials with different characteristics from the individual components.

The addition of the ceramic platelets significantly modifies the properties of the elastomer. The inventors propose that the elastomer serves as a matrix and the ceramic platelets align within the elastomer matrix.

The ceramic platelets may constitute no more than 50 vol % of the elastomer/composition. The composition (or elastomer) may comprise 45 vol % or less, 40 vol % or less, 35 vol % or less, 30 vol % or less, 25 vol % or less or 20 vol % or less and/or the composition (or elastomer) may comprise 5 vol % or more, 10 vol % or more, 15 vol % or more, 20 vol % or more, 25 vol % or more, 30 vol % or more, or 40 vol % or more. Without being bound by theory, the inventors propose that platelet to platelet contact should be avoided to provide favourable properties in the composite.

The use of 20 vol % or more, e.g. 20 to 30 vol %, is especially useful for ballistic applications.

The ceramic platelets may constitute no more than 70 wt % of the composition. The composition may comprise 65 wt % or less, 60 wt % or less, 55 wt % or less, 50 wt % or less, 45 wt % or less, 40 wt % or less or 30 wt % or less ceramic platelets and/or the composition may comprise 10 wt % or more, 20 wt % or more, 30 wt % or more or 40 wt % or more ceramic platelets.

Additional components may be dispersed within the elastomer in addition to the ceramic platelets. Suitable additional components include carbon black, silica and/or nano clays. Such additional components may be present at 20 vol % or less, 10 vol % or less, 5 vol % or less, 2 vol % or less or 1 vol % or less.

The composition may consist of the elastomer having the ceramic platelets dispersed therein.

The ceramic platelets may be aligned within the elastomer. The ceramic platelets may be aligned within the elastomer while avoiding platelet-platelet contact. The inventors consider this structure to be important for maintaining the beneficial properties of the composite.

The composition may comprise an elastomer having a single phase i.e. having uniform properties. The use of elastomers having hard and soft domains is not preferred. The ceramic platelets provide reinforcement within the elastomer and the presence of hard domains may disrupt the structure of the composite.

Methods

Methods in accordance with the second aspect of the invention include melt mixing and solvent casting methods. Extrusion, biaxial stretching and/or pressing can be employed to increase alignment of the platelets within the elastomer.

The method of the second aspect may comprise a melt mixing method. Melt mixing is a standard, easily scalable method which is more environmentally friendly than solvent-gel casting, due to the lack of solvents (which may be toxic) and shorter processing times. For example, the method may comprise combining the ceramic platelets and the elastomer to obtain a molten mixture comprising the elastomer and the ceramic platelets; and

cooling the molten mixture to form a solid mixture.

The solid mixture may be hot-pressed, extruded or stretched to form a composite layer.

The (single) composite layer may have a thickness of at least 200 μm, at least 500 m, at least 700 m, at least 1 mm (1000 μm), at least 2 mm, at least 10 mm, at least 50 mm or at least 100 mm and/or the (single) composite layer may have a thickness of 100 mm or less, 50 mm or less, 30 mm or less, 10 mm or less, 5 mm or less, or 3 mm or less. The thickness may be measured using callipers, dial indicator or other standard measurement methods.

The composite layer may be cut into sheets, stacked and hot pressed to form a laminate. Surprisingly, the inventors have determined that the ceramic platelets have satisfactory alignment without hot pressing a plurality of sheets. However, hot pressing increases the alignment of the ceramic platelets within the elastomer.

The method may comprise a solvent casting method. For example, the method may comprise providing a suspension of ceramic platelets in a solvent;

combining the suspension with an elastomer to obtain a mixture comprising ceramic platelets, solvent and elastomer;

casting the mixture to form a film; and

drying the film to remove the solvent and thereby form a composite layer.

The (single) composite layer may have a thickness of at least 100 μm, at least 300 m, at least 500 m, or at least 1 mm (1000 μm) and/or the (single) composite layer may have a thickness of 5 mm or less, 3 mm or less, or 1 mm or less.

The composite layer (produced by melt mixing, solvent casting or another method) may be cut into sheets, stacked and hot pressed to form a laminate. The laminate may comprise 2 or more, 5 or more or 10 or more sheets and/or the laminate may comprise 50 or fewer, 20 or fewer or 10 or fewer sheets.

The laminate may have a thickness of at least at least 500 μm, at least 1 mm (1000 μm), at least 2 mm, or at least 4 mm and/or the laminate may have a thickness of 20 mm or less, 10 mm or less, or 5 mm or less.

Applications

The inventors have determined that the composite of the invention has particular benefits for (i) ballistic applications and (ii) vibration damping.

Some soft elastomeric polymers such as butyl rubber and PIB undergo a hard, brittle state change when impacted at ballistic rates. This brittle fracturing has been correlated to increased ballistic resistance.

The invention provides an armour system comprising a first rigid substrate and the composition of the first aspect of the invention. The composition may comprise ceramic platelets aligned in a plane parallel to the first rigid substrate.

The composition may be located between the first rigid substrate and a second rigid substrate, e.g. the armour system may comprise a blast sandwich panel.

The first and second rigid substrates may comprise steel, aluminium alloy or concrete for example

The composition may be employed as a strike face for both metal and ceramic components of armour systems. Such a system may be retrofitted or built into new armour packs. The composition may be applied as a layer (e.g. a layer having a thickness of 2 mm or more) on an outer face of an armour pack. Such a strike face layer is multifunctional: it absorbs a significant proportion of the projectile's kinetic energy, damps shockwaves and captures shrapnel.

The composition may be employed as a spall liner (rear face of armour)

The composition may be employed in an anti-vibration mount i.e. to reduce vibration.

The invention is further described, in a non-limiting manner, with reference to the following figures:

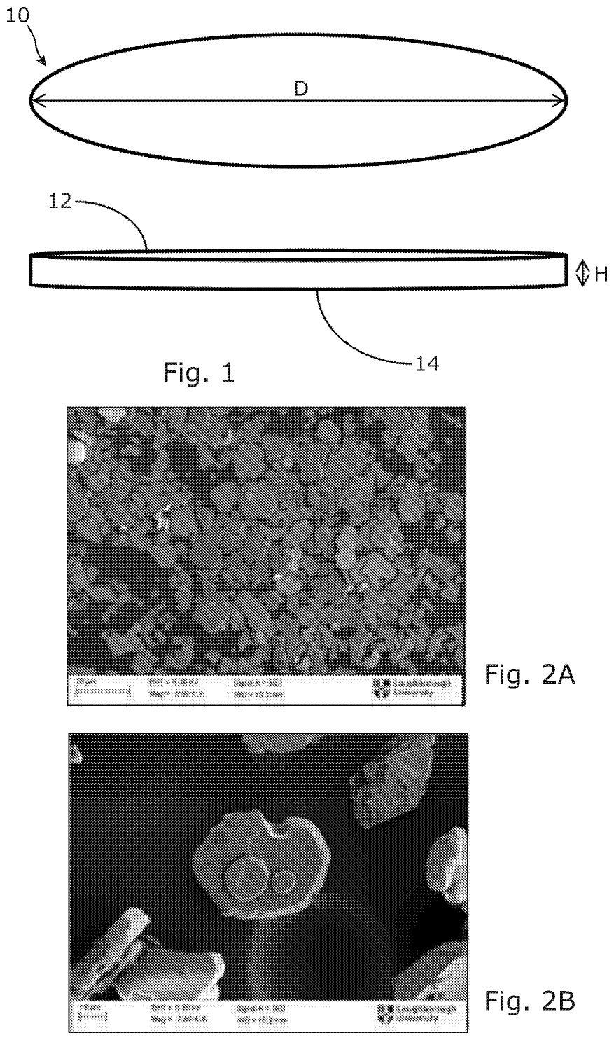

FIG. 1 is a schematic diagram (of a ceramic platelet for use in embodiments of the invention;

FIG. 2 shows SEM images of Alusion® alumina sub-micro platelets (FIG. 2A, scale 20 μm) and PWA 20 micro platelets (FIG. 2B, scale 10 m);

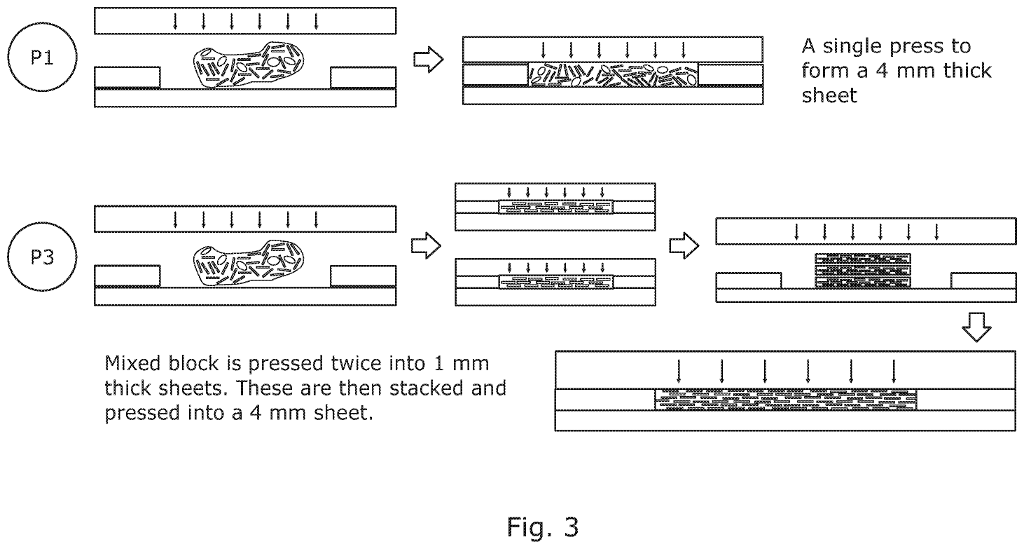

FIG. 3 is a schematic diagram demonstrating hot-pressing;

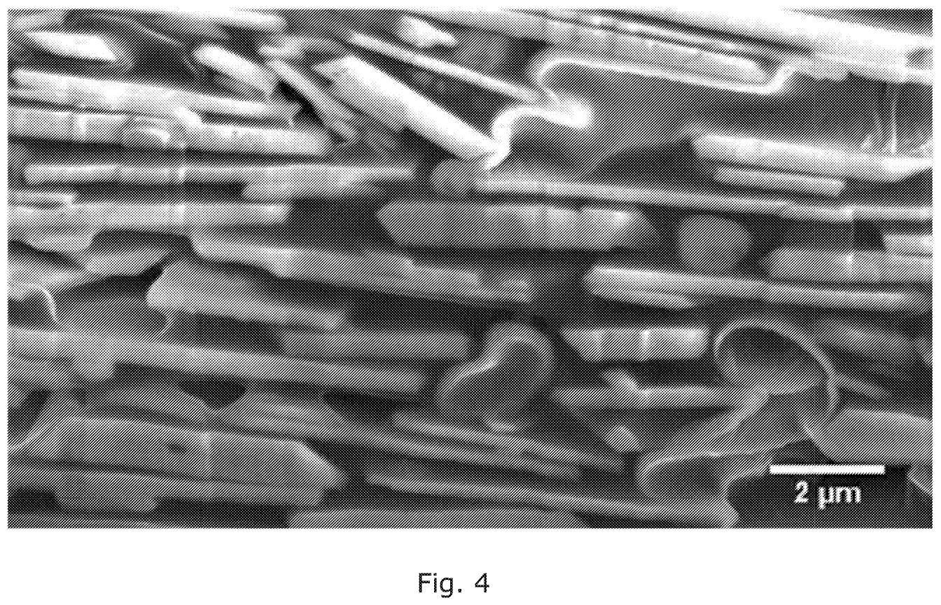

FIG. 4 shows an FIB section of Ex. 7 with a scale of 10 m;

FIG. 5 is graph showing true stress for a composition in accordance with the invention (upper line) and comparative examples (lower lines);

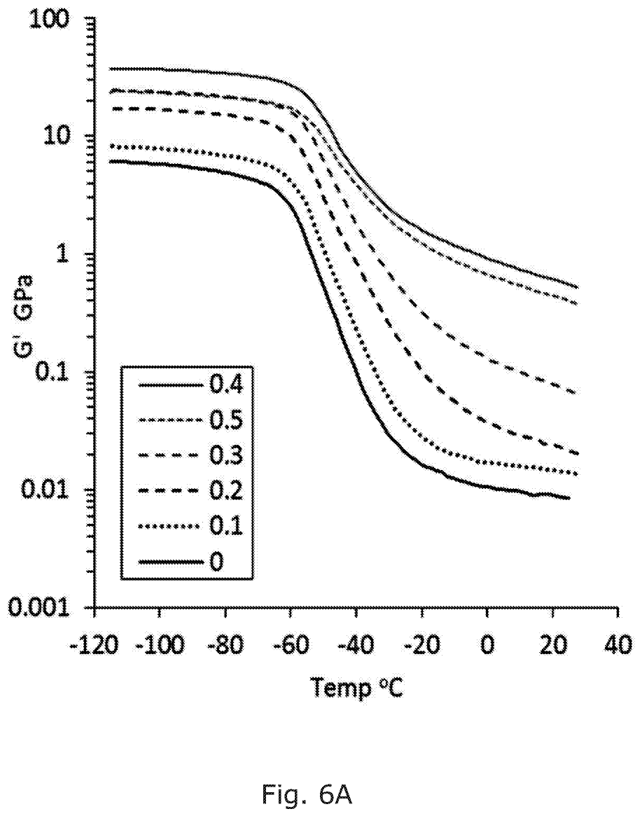

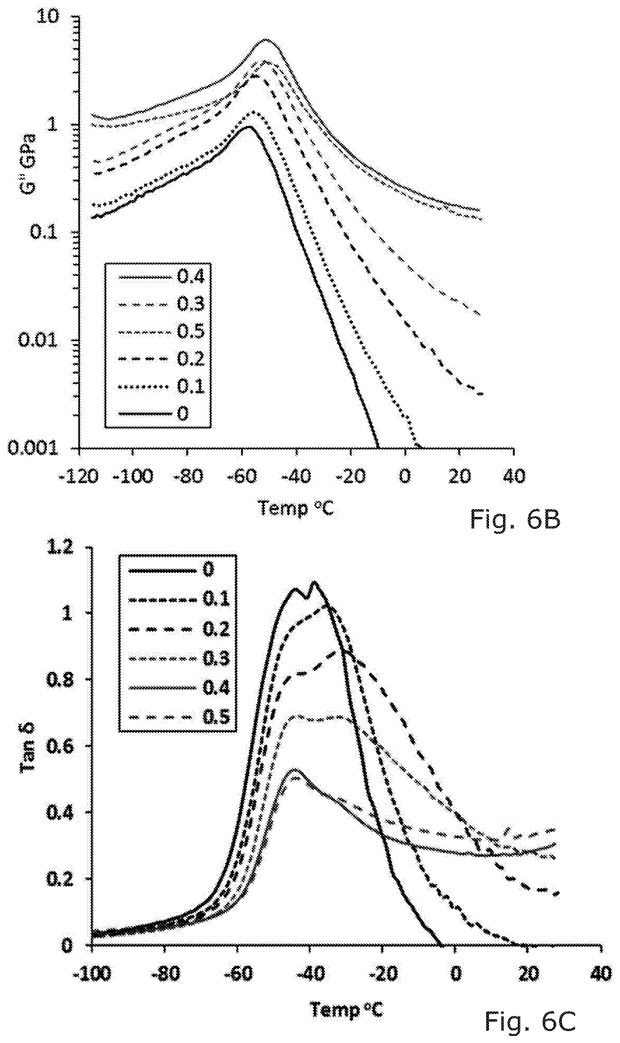

FIG. 6 shows graphs of G′ (storage modulus), G″ (loss modulus) and tan δ (phase lag between stress and strain), all measured at 1 Hz;

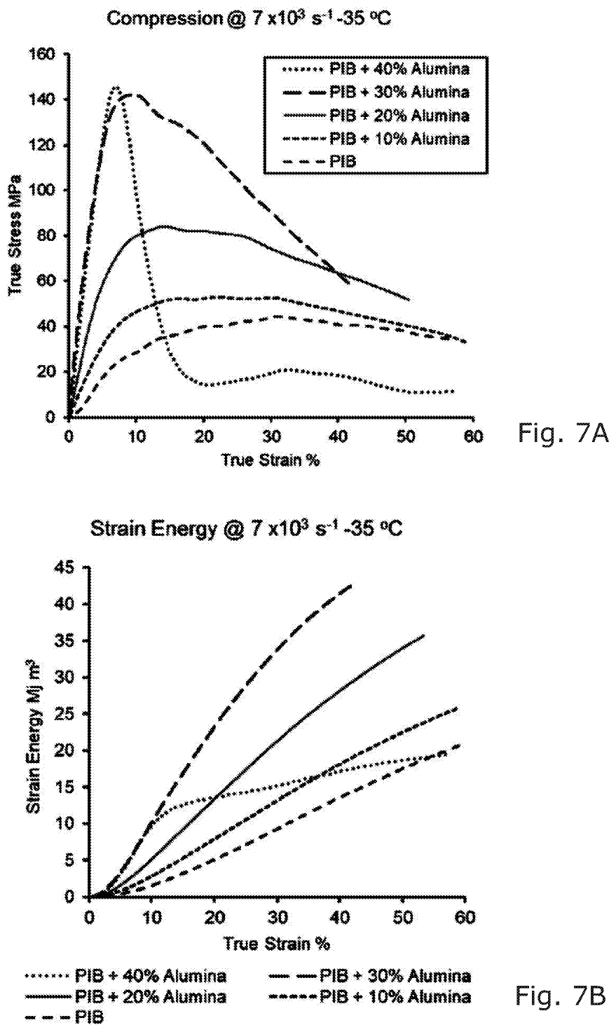

FIG. 7 shows graphs of true stress and strain energy;

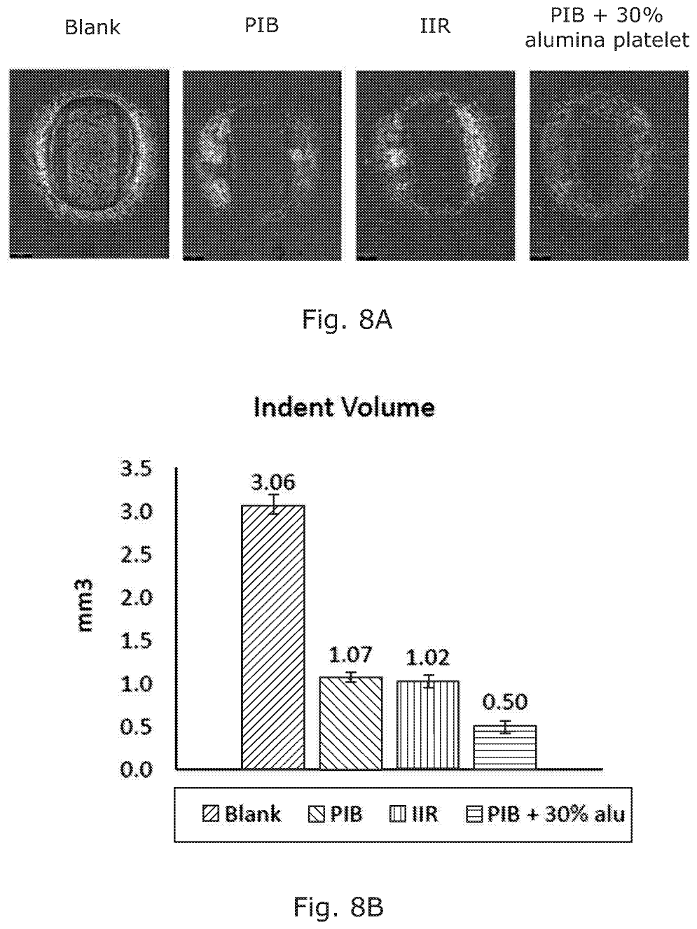

FIG. 8 shows the results of ballistics tests;

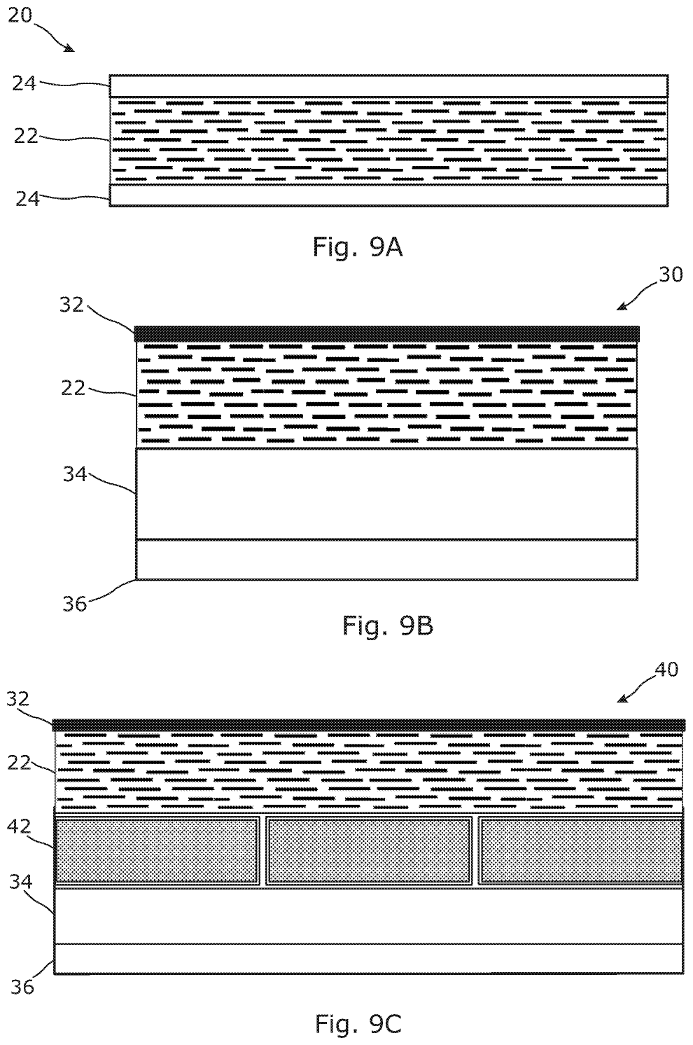

FIG. 9 shows schematic diagrams (not to scale) of armour systems in accordance with embodiments of the invention; and

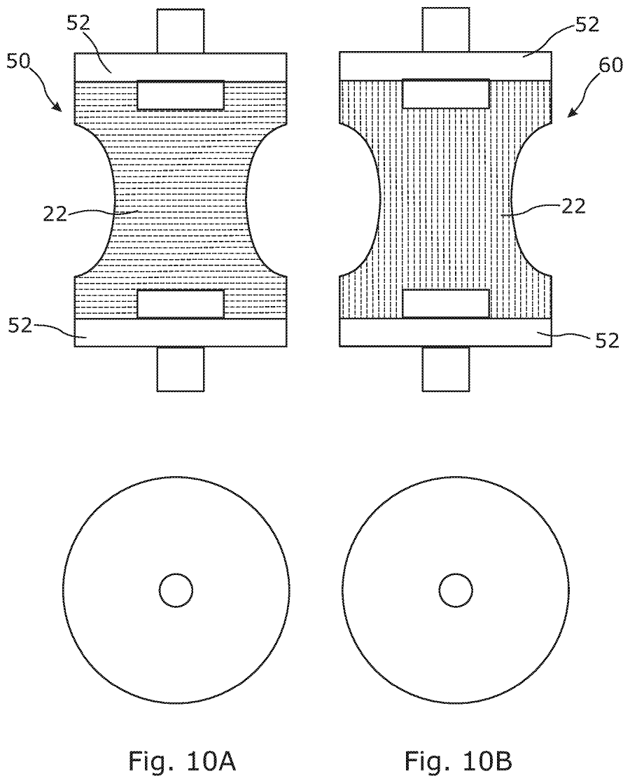

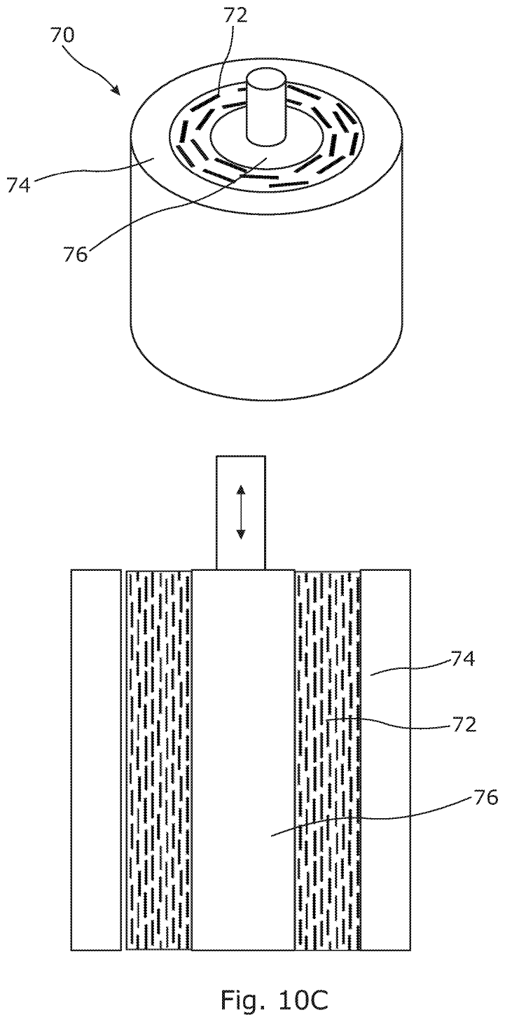

FIG. 10 shows schematic diagrams (not to scale) of vibration mounts in accordance with embodiments of the invention.

FIG. 1 is a schematic diagram (not to scale) of a ceramic platelet 10, shown from above (upper image) and a perspective view from the side (lower image). The platelet 10 has a first (upper) plate surface 12 and a second (lower) plate surface 14, the plate surfaces 12, 14 being separated by a height H. The first plate surface 12 has a maximum diameter D. The second plate surface 14 is identical to the first surface so the maximum diameter of the second plate surface 14 is equal to the maximum diameter of the first plate surface 12. If the plate surfaces were different, then the longer maximum diameter would be considered.

Each of the ceramic platelets within the elastomer will have a maximum diameter D and a height H, and there is likely to be dispersion. However a mean diameter Dₘ and mean height Hₘ can be determined. The ceramic platelets of the invention have a ratio of Dₘ to Hₘ of at least 20.

The platelet 10 is shown as having an oval cross-section for simplicity, but the cross-section is likely to be irregular in practice. For example, platelets may be prepared from a single crystal having a uniform height which breaks to provide platelets of various sizes, but identical heights.

### Summary of Examples

| | | | | Vol |
|---|---|---|---|---|
| Example | Manufacture | Elastomer | Ceramic particle | % |
| Comp. | Melt mix | PIB | Alumina powder | 30 |
| Ex. 1 | | | | |
| Comp. | Melt mix | PIB | PWA 20 micro | 30 |
| Ex. 2 | | | platelets | |
| Ex. 1 | Melt mix | PIB | Alusion ® sub-micro | 30 |
| | | | platelets | |
| Ex. 2 | Melt mix, rubber | Butyl | Alusion ® sub-micro | 30 |
| | compounding | rubber | platelets | |
| | without sulphur | | | |
| Ex. 3 | Melt mix, rubber | Butyl | Alusion ® sub-micro | 30 |
| | compounding | rubber | platelets | |
| | with sulphur | | | |
| Ex. 4 | Solvent cast | PIB | Alusion ® sub-micro | 10 |
| | | | platelets | |
| Ex. 5 | Solvent cast | PIB | Alusion ® sub-micro | 20 |
| | | | platelets | |
| Ex. 6 | Solvent cast | PIB | Alusion ® sub-micro | 30 |
| | | | platelets | |
| Ex. 7 | Solvent cast | PIB | Alusion ® sub-micro | 40 |
| | | | platelets | |
| Ex. 8 | Solvent cast | PIB | Alusion ® sub-micro | 50 |
| | | | platelets | |

Materials and Methods

Composites were manufactured with a matrix polymer of polyisobutylene (Oppanol® N80, BASF, UK) MW 1,100,000, or butyl rubber (Butyl 402, LANXESS) with an unsaturation of 2.25% mol and a Mooney viscosity of 33 MU. The platelet dimensions were determined from SEM imaging (FIG. 2) and are consistent with the literature values shown in the table below.

| | Mean maximum | Mean | | |
|---|---|---|---|---|
| | diameter | height | | |
| Ceramic particle | Dₘ (μm) | Hₘ (μm) | | Dₘ:Hₘ |
| Alumina powder | 10 | 10 | | 1 |
| (Sigma Aldrich, 99.9% | | | | |
| pure) | | | | |
| PWA 20 micro platelets | 19.52 (SD 4.98) | 3.12 | (0.79) | 6.3 |
| (Fujimi Corporation) | | | | |
| Alusion ® sub-micro | 12.66 (SD 2.28) | 0.36 | (SD 0.08) | 35.2 |
| platelets (Antaria Ltd, | | | | |
| Australia) | | | | |

Melt Mixing

Composites with PIB matrices were melt mixed using a HAAKE® Rheomix600 mixing rheometer with Banbury rotors, resulting in a chamber volume of 78 cm³. For all compounds a chamber fill ratio of 0.7 was applied. If a surface modifier (e.g. silane treatment) is desired, it can be applied to platelets through a pre-treatment process.

PIB composites were melt mixed at 140° C. at 50 rpm for 10 minutes, reaching a maximum of no more than 175° C. to avoid degradation. The resulting mixture was air cooled before being hot pressed (160° C. for 4 minutes with a force of 250 kN). This was repeated once more to make a 1 mm thick sheet for DMA samples, remaining material was then repressed into a 4 mm thick sheet for SHPB samples. DMA strips of 12×30 mm were punched from the 1 mm sheet. Cylindrical SHPB sample discs of 8 mm diameter were cut from the 4 mm thick sheet using a biopsy punch.

| | | Start | End | | | | | |
|---|---|---|---|---|---|---|---|---|
| | | thickness | thickness | Temperature | Load | Pre-heat | Press | Cool |
| Stage | Presses | (mm) | (mm) | (° C.) | (kN) | (minutes) | (minutes) | (minutes) |
| 1 | 2 | 4 | 1 | 160 | 250 | 2 | 2 | 1 |
| 2 | 1 | 6 | 2 | 160 | 250 | 2 | 2 | 1 |
| 3 | 1 | 8 | 4 | 160 | 250 | 4 | 2.5 | 2 |

Hot pressing was used as a method of increasing alignment. To explore the influence of alignment, samples were taken after one pressing (P1) and three pressings (P3), as illustrated in FIG. 3. The melt mixed composites exhibited a significant increase in both modulus (330 to 390 MPa) and strength (4.7 to 5.3 MPa) with repeated pressings (P1 to P3). This could be a result of increasing dispersion or alignment with repeat pressings.

A basic curing system was employed for the butyl rubber examples, using a sulphur crosslinking mechanism with TMTD (tetramethylthiuram disulphide), as an accelerator. Zinc oxide was also added to the compound as an activator. The compounding formulation used in the manufacture of the composites is shown below:

| | Parts per hundred | Weight percent | Volume fraction |
|---|---|---|---|
| | (pph) | (% wt) | (V) |
| Sulphur | 2 | 0.70 | 0.006 |
| Zinc oxide | 3 | 1.05 | 0.004 |
| TMTD | 5 | 2.09 | 0.026 |
| Butyl rubber | 100 | 34.84 | 0.675 |
| Alumina | 177 | 61.67 | 0.289 |

Butyl rubber composites were compounded in two stages, a high temperature melt mixing of the platelets, and a reduced temperature mixing of curing agents. Both stages were performed with the use of a HAAKE® Rheomix600 with Banbury rotors, resulting in a chamber volume of 78 cm³. For all compounds a chamber fill ratio of 0.7 was applied.

Solvent-Gel Casting

A solvent cast and hot-pressing method was developed based on Bonderer et al (J. Mater. Res. 24, 2741-2754 (2009). A suspension of alumina platelets in toluene was created and PIB was added to achieve the desired polymer solution.

The resulting polymer-ceramic-solvent mixtures were cast into large thin films, ≈500 m thick when dry, and dried at 60° C. for 24 hours. The dry films were cut into 20×20 mm sheets, stacked and hot pressed at 160° C. for 4 minutes with a force of 250 kN, then rapidly cooled, this was repeated once more to make a 1 mm thick sheet for DMA samples, remaining material was then repressed into a 4 mm thick sheet for SHPB samples. DMA strips of 12×24 mm were punched from the 1 mm sheet. Cylindrical SHPB sample discs of 8 mm diameter were cut from the 4 mm thick sheet using a biopsy punch (see table above for hot-press parameters).

Results

Structure

A combination of cryofracture face and FIB section views were used to characterise the structure. Imaging cryofractures allowed the alignment of platelets in the composites to be measured and gave an indication of dispersion. FIB (focussed ion beam) sections allowed dispersion to be studied in more accuracy but alignment cannot be assessed due to the small section area.

Both cryofractures and FIB sections showed good platelet dispersion over all contents. Within the small area of FIB sections platelets appeared evenly dispersed. The majority of platelets are singularly dispersed and even at 0.4 Vₚ (40 vol %) when platelets are forced into close proximity, a layer of elastomer is present between adjacent platelets. For example, FIG. 4 shows a gallium ion FIB section of Ex. 7, which is a PIB composite comprising 40 vol % sub-micro alumina platelets.

Dynamic Materials Analysis (DMA) and Split Hopkinson Pressure Bar (SHPB)

DMA was used to study viscoelastic properties across the Tg, and SHPB tests were employed to determine high strain rate and high deformation properties.

DMA was performed using the TA Instruments Q800 with a single cantilever configuration. Tests were performed over a temperature range of −115 to 30° C. at a ramp rate of 3° min⁻¹, in order to traverse the Tg. All samples were analysed at frequencies of 1, 10 and 100 Hz.

High strain rate, high deformation, compression properties were determined using a SHPB. Aluminium alloy 6082 T6 bars with a diameter of 12.7 mm were used. The system uses a rapid release of a vacuum chamber to accelerate a striker bar within a sabot at speeds of up to 20 ms⁻¹. Stress waves within the bars were measured using pairs of strain gauges with a resistance of 120Ω.

FIG. 5 demonstrates that the type of ceramic platelet affects the properties of the resulting composite: Comp Ex 0.1 employs alumina powder (Dₘ:Tₘ=1), Comp Ex. 2 employs alumina micro platelets (Dₘ:Tₘ=6.3) and Ex. 1 employs sub-micro alumina platelets (Dₘ:Tₘ=35.2).

The modulus and strength properties are shown in the table below.

| | |
|---|---|
| SHPB 20° C. | SHPB −35° C. |

| | Modulus | UCS | Modulus | UCS |
|---|---|---|---|---|
| | (MPa) | (MPa) | (GPa) | (MPa) |
| Ex. 1 | 394 | 53.3 | 1.7 | 112 |
| Comp Ex. 1 | 148 | 21.0 | 1.2 | 74 |
| Comp. Ex. 2 | 198 | 24.2 | — | — |

Both ambient and low temperature SHPB compressive tests show a large reduction in both modulus and strength compared to that of the sub-micro platelets. Comp. Ex. 1 (alumina powder) exhibiting a 61% and 34% reduction in strength at 20° C. and −35° C. respectively when compared to Ex. 1 (sub-micro platelets).

It is clear from this that the increase in modulus, strength and strain energy observed from the addition of sub-micro alumina platelets are far greater than would normally be achieved by simple particle reinforcement. This being direct evidence that the size and aspect ratio of these platelets is highly beneficial in reinforcement both above and below the T_{g}.

FIGS. 6A, 6B and 6C show that the use of ceramic platelets in accordance with the invention provided huge increases in storage and loss modulus and a broadening of tan δ but a reduction in peak height. The reinforcing effect of the platelets changes with strain rate and proportion of ceramic platelets.

When considering platelet volume, a steady increase in G′ was observed with increasing Vₚ across the full temperature range. There was a noticeable increase in G′ from 0.3 to 0.4 Vₚ above the Tg. G″ peaks increased proportionally, up to 0.4 Vₚ. At 0.5 Vₚ the composites exhibited a G″ peak lower than the 0.4 Vₚ and similar to the 0.3 Vₚ. There were also large increases in G″ both above and below the Tg with increasing platelet content up to a content of 0.4 Vₚ.

FIG. 7 shows the SHPB (Split Hopkinson Pressure Bar) properties of composites depending on the vol % of ceramic platelets (examples 4 to 8). 40 vol % showed early failure with reduced strain energy absorption. 30 vol % showed the same ultimate strength but increased toughness with only 15% plastic strain on release. Compression was determined at −35° C. to simulate ballistic performance.

Ballistic Performance

A 5 mm diameter 1.1 g steel fragment was employed to simulate a projectile, at a projectile velocity of 320 ms⁻¹ (716 miles per hour). The composite was applied as a 2 mm layer to a 5 mm Armox® 440 steel plate. There was a visible reduction in dent severity when 30 vol % sub-micro alumina platelets were employed, as shown in FIG. 8A, and illustrated in the bar chart FIG. 8B.

Damping or relaxation mechanisms are thought to have a significant contribution to strike face ballistic performance. As such, how the relaxation mechanisms are affected by the addition of platelets could therefore be critical in determining the ballistic performance of the composite. The relaxation mechanisms were investigated across the Tg using DMA, with detailed tan δ peaks being obtained at 1 Hz.

It was observed that the peak form changed significantly with the introduction of alumina platelets. PIB has two identifiable relaxation peaks within the tan δ T_{g} peak. These peaks being identified as P1 and P2, corresponding to the sub-Rouse and Rouse relaxation modes respectively.

Armour System

The composition of the invention is particularly useful for ballistics applications, such as armour systems.

FIG. 9A shows a cross-section of a blast panel 20 in accordance with an embodiment of the invention. The blast panel 20 contains a layer of composite material 22, which is sandwiched between two rigid plates 24 (e.g. steel or aluminium alloy). It can be observed that composite material 22 contains aligned ceramic platelets, the alignment being in parallel with the rigid plates 24.

FIG. 9B shows a cross-section of an armour system 30 for protection against small arms. The armour system 30 has an environmental cover 32 on its front face and the composite material 22 is located as a layer between the environmental cover and a rigid backing 34 (e.g. steel, aluminium or a another ballistic resistant composite, such as Kevlar®). A spall liner 36 can be applied to the opposite side of the rigid backing 34.

FIG. 9C shows an armour system 40 with ceramic tiles for protection against armour piercing rounds. The armour system is similar to that shown in FIG. 9B except that there is an additional layer of ceramic tiles 42 located between the layer of composite material 22 and the rigid backing 34.

Vibration Damping

FIG. 10 shows anti-vibration mounting systems comprising a composition in accordance with embodiments of the invention.

FIGS. 10A and 10B show vibration mounts 50 and 60, each of which comprise the composition 22 in accordance with an embodiment of the invention. The composition is “sandwiched” between two rigid (e.g. steel) discs 52. In system 50 the ceramic platelets are aligned parallel to the discs 52 whereas in system 60 the ceramic platelets are aligned perpendicular to the discs 52.

FIG. 10C shows a cylindrical anti-vibration mount 70 comprising a composition 72 in accordance with an embodiment of the invention. The composition 72 is formed into a tubular shape “sandwiched” between an outer rigid collar 74 and an inner cylindrical core 76. The ceramic platelets within the composition are aligned parallel with the rigid outer collar 76.

1. A composition comprising an elastomer having ceramic platelets dispersed therein,
the ceramic platelets each having a first plate surface and a second plate surface, the first and second plate surfaces being separated by a height H;
the ceramic platelets each having a maximum diameter D measured in the first and second plate surfaces; and
the ceramic platelets having a mean height Hm and a mean maximum diameter Dm; wherein Hm is 0.1 to 1 μm and the ratio Dm:Hm is 20 or more.

2. The composition of claim 1, wherein the ratio Dm:Hm is 30 or more.

3. The composition of claim 1, wherein the mean height Hm of the ceramic platelets is 300 nm or more and/or the mean maximum diameter Dm is 10 μm or more.

4. The composition of claim 1, wherein the elastomer comprises butyl rubber, polyisobutylene (PIB), natural rubber (polyisoprene), polybutadiene rubber (BR), styrene-butadiene rubber (SBR), nitrile rubber (NBR), chloroprene rubber (CR), ethylene propylene rubber (EPM), ethylene propylene diene rubber (EPDM), and/or silicone.

5. The composition of claim 1, wherein the elastomer comprises butyl rubber, polyisobutylene (PIB), natural rubber (polyisoprene), polybutadiene rubber (BR), styrene-butadiene rubber (SBR), nitrile rubber (NBR), chloroprene rubber (CR), ethylene propylene rubber (EPM), and/or ethylene propylene diene rubber (EPDM).

6. The composition of claim 1, wherein the elastomer comprises one or more saturated rubbers, optionally blended with one or more unsaturated rubbers.

7. The composition of claim 1, wherein the elastomer comprises butyl rubber, optionally blended with polyisobutylene.

8. The composition of claim 1, wherein the ceramic platelets are metal oxide, metal nitride and/or a metal carbide platelets.

9. The composition of claim 1, wherein the ceramic platelets are alumina platelets.

10. The composition of claim 1, wherein the ceramic platelets are silane treated ceramic platelets.

11. The composition of claim 1, consisting of the elastomer having the ceramic platelets dispersed therein.

12. The composition of claim 1, wherein the ceramic platelets constitute no more than 50 vol % of the composition.

13. The composition of claim 12, wherein the ceramic platelets constitute 20 to 30 vol % of the composition.

14. A method for the preparation of the composition of claim 1, the method comprising
dispersing ceramic platelets in an elastomer,
the ceramic platelets each having a first plate surface and a second plate surface, the first and second plate surfaces being separated by a height H;
the ceramic platelets each having a maximum diameter D measured in the first and second plate surfaces; and
the ceramic platelets having a mean height Hm and mean maximum diameter Dm; wherein Hm is 0.1 to 1 μm and the ratio of Dm:Hm is 20 or more.

15. The method of claim 14, which is a melt mixing method.

16. The method of claim 14, additionally comprising hot-pressing, extruding or bi-axial stretching to increase alignment of the platelets within the elastomer.

17. (canceled)

18. An armour system comprising a rigid substrate and the composition of claim 1.

19. (canceled)

20. The composition of claim 1, wherein the ratio Dₘ:Hₘ is 30 to 50.
